(19) United States
(12) Patent Application Publication
(10) Pub. No.: US 2018/0318766 A1
(43) Pub. Date: Nov. 8, 2018

(54) WATER RECLAMATION SYSTEM

(71) Applicant: Mark Malmquist, Irvine, CA (US)

(72) Inventor: Mark Malmquist, Irvine, CA (US)

(21) Appl. No.: 15/969,067

(22) Filed: May 2, 2018

Related U.S. Application Data
(60) Provisional application No. 62/501,991, filed on May 5, 2017.

(51) Int. Cl. B01D 61/04; B01D 61/08; B01D 61/02; B01D 65/08

(52) U.S. Cl. CPC B01D 61/04; B01D 61/08; B01D 61/025; B01D 2317/022; B01D 2311/04; B01D 2321/2041; B01D 65/08

(57) ABSTRACT

A reverse osmosis main plant which may receive non-potable water and discharge out permeate through a permeate out line and concentrate through a concentrate line is disclosed.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The various aspects and embodiments disclosed herein relate to a water treatment center.

A water treatment center processes lower quality water (e.g. seawater or non-potable groundwater) through a reverse osmosis system. The reverse osmosis system will be able to process the lower quality water so that about 80% of the non-potable water is sent to the end-user while the other 20% of the non-potable water is dumped back into the environment. The process water that is sent to the end user is often referred to as permeate water. The potable water that is not potable and dumped back into the environment is often referred to as concentrate water.

There is a need in the art for reducing the amount of concentrate being introduced into the environment which has a higher concentration of minerals that might damage the environment than the lower quality water being processed.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a reverse osmosis plant.

### DETAILED DESCRIPTION

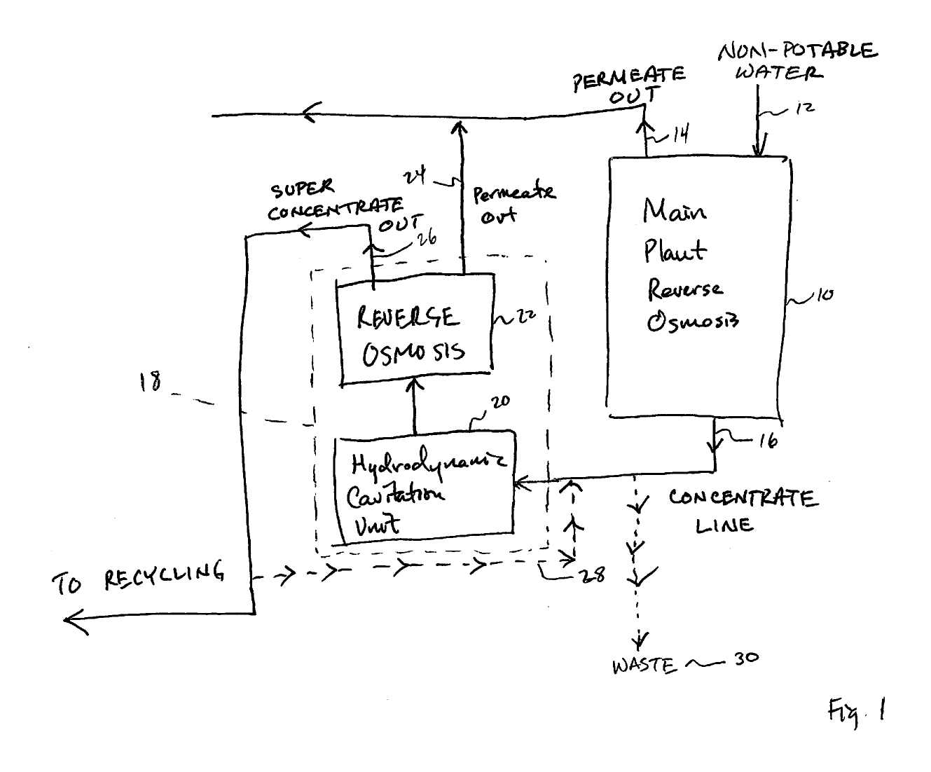

Referring now to FIG. 1, a reverse osmosis main plant 10 is shown. The reverse osmosis main plant 10 may receive non-potable water 12 and discharge out permeate through the permeate out line 14 and concentrate through the concentrate line 16. Typically, 20% of the non-potable water is discharged out of the concentrate line 16 as concentrate. A concentrate processing system 18 may receive the concentrate out of the concentrate line 16. The concentrate has a higher level or concentration of minerals compared to the non-potable water. The concentrate is processed with a hydrodynamic cavitation unit 20 and the cavitated water is processed by a reverse osmosis unit 22. The reverse osmosis unit 22 produces permeate water and discharges the permeate water through the permeate out line 24 and joins the permeate out line 14 of the reverse osmosis main plant 10. The permeate water from the reverse osmosis unit 22 and the reverse osmosis main plant 10 may be treated then sent to the end user for consumption.

The reverse osmosis unit 22 also has a concentrate out line which may be referred to as a super concentrate line because the concentration of minerals in the super concentrate is higher than the concentration of minerals discharged from the concentrate line 16 of the reverse osmosis main plant 10.

The hydrodynamic cavitation unit 20 changes the molecular structure of the concentrate out of the reverse osmosis main plant 10 so that the unwanted minerals do not foul a membrane of the reverse osmosis unit 22. Rather, the change in the molecular structure of the concentrate reduces the amount of minerals that might foul or attach to the membrane of the reverse osmosis unit 22. Additionally, mitigation of the minerals from attaching to the membrane of the reverse osmosis unit 22 is also due to the high pressure in which the reverse osmosis unit 22 operates. By way of example and not limitation, the cavitated water may experience pressures above 200 psi and more preferably between 300 to 400 psi in the reverse osmosis unit 22. Cavitation of the concentrate water along with the high pressure induced on the cavitated water reduces the amount of minerals that would have attached to the membrane of the reverse osmosis unit 22.

By mitigating or reducing the amount of minerals that attach to the membrane of the reverse osmosis unit 22, the lifespan of the reverse osmosis unit 22 is extended. Moreover, the reverse osmosis unit 22 produces a super concentrate coming out of the super concentrate out line 26. The minerals in the super concentrate begin to form as undissolved solids (e.g., hydrophobic material) so that the super concentrate can be sent to recycling for removal of the undissolved solids and eventually sold to an end user.

The hydrodynamic cavitation unit 20 may cavitate the concentrate water at temperatures at or around 3000° F. or more (e.g., 4000° F.) and pressures at or around 75 psi to 100 psi or more. The hydrodynamic cavitation unit 20 may be a rotary shear type cavitation unit, a shear plate type cavitation unit or an orifice type cavitation unit.

The concentrate processing system 18 may receive the concentrate from the reverse osmosis main plant 10 and 50% of the concentrate may be discharged out to the permeate out line 24. The other 50% is considered a super concentrate and sent to recycling to capture or remove the undissolved solids, minerals that are valuable and contained within the super concentrate of the concentrate processing system 18. The undissolved solids and minerals may include one or more of the following but are not limited to calcium sulfate, calcium, potassium, magnesium, sulfer, phosphorus and selenium.

It is also contemplated that the super concentrate from the super concentrate out line 26 may be recycled back to the hydrodynamic cavitation unit 20 through line 28. Additionally, the concentrate from the concentrate line 16 may be diverted away from the concentrate processing system 18 to waste 30.

The undissolved solids from the super concentrate may be a hydrophobic solid that can be removed and recycled for further use.

The cavitated water in lieu of being processed with a reverse osmosis unit 22 may be subjected to high pressures which would begin to solidify the minerals as a hydrophobic material. In this instance, no permeate water is produced but the minerals in hydrophobic solid form may be removed and recycled for further use.

It is also contemplated that a hydrodynamic cavitation unit may be placed upstream from the reverse osmosis main plant 10 in order to mitigate fouling of the membrane of the reverse osmosis main plant 10 which may increase life and uptime of the reverse osmosis main plant 10.

Other ways of producing the hydrophobic solid is by running a DC current through the super concentrate via an anode and a cathode. The hydrophobic solid will collect on the anode. The electricity may be shut off and the material with be captured off of the anode.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A reverse osmosis plant comprising:
A hydrodynamic cavitatic unit for receiving concentrate from a reverse osmosis main plant; and
A reverse osmosis unit of a concentrate processing system for treating the concentrate from the reverse osmosis main plant.
